(19) United States
(12) Patent Application Publication
(10) Pub. No.: US 2013/0174234 A1
(43) Pub. Date: Jul. 4, 2013

(54) LIGHT-WEIGHT CREDENTIAL SYNCHRONIZATION

(71) Applicants: Jingsheng Yang, Shanghai (CN); Hui Shao, Shanghai (CN); Rong Yu, Shanghai (CN)

(72) Inventors: Jingsheng Yang, Shanghai (CN); Hui Shao, Shanghai (CN); Rong Yu, Shanghai (CN)

(73) Assignee: Microsoft Corporation, Redmond, WA (US)

(21) Appl. No.: 13/339,364

(22) Filed: Dec. 28, 2011

(51) Int. Cl. G06F 21/00

(52) U.S. Cl. 726/6

(57) ABSTRACT

Aspects of the subject matter described herein relate to credential synchronization. In aspects, an entity may have access to resources on two or more systems. After the entity's credentials are changed on a first system, the first system updates the credentials on a second system so that the entity can access resources on the second system using the new credentials. The first system maintains a mapping data structure that maps between the credentials data of the two systems. The first system may obtain credential requirements from the second system and provide these requirements in conjunction with receiving a request to change credentials so that a user changing the credentials may satisfy both systems.

### BACKGROUND

Today, many people are required to maintain multiple passwords or other credentials. For example, a person may have one password to use to access one set of resources and another password to use to access another set of related resources. Keeping track of the passwords and changing them periodically on each system that provides the resources add to a user's workload. The work involved in maintaining passwords or other credentials may discourage organizations from adopting or even trying new technologies.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to credential synchronization. In aspects, an entity may have access to resources on two or more systems. After the entity's credentials are changed on a first system, the first system updates the credentials on a second system so that the entity can access resources on the second system using the new credentials. The first system maintains a mapping data structure that maps between the credentials data of the two systems. The first system may obtain credential requirements from the second system and provide these requirements in conjunction with receiving a request to change credentials so that a user changing the credentials may satisfy both systems.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that represents an exemplary environment in which aspects of the subject matter described herein may be implemented; and

FIGS. 3-5 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

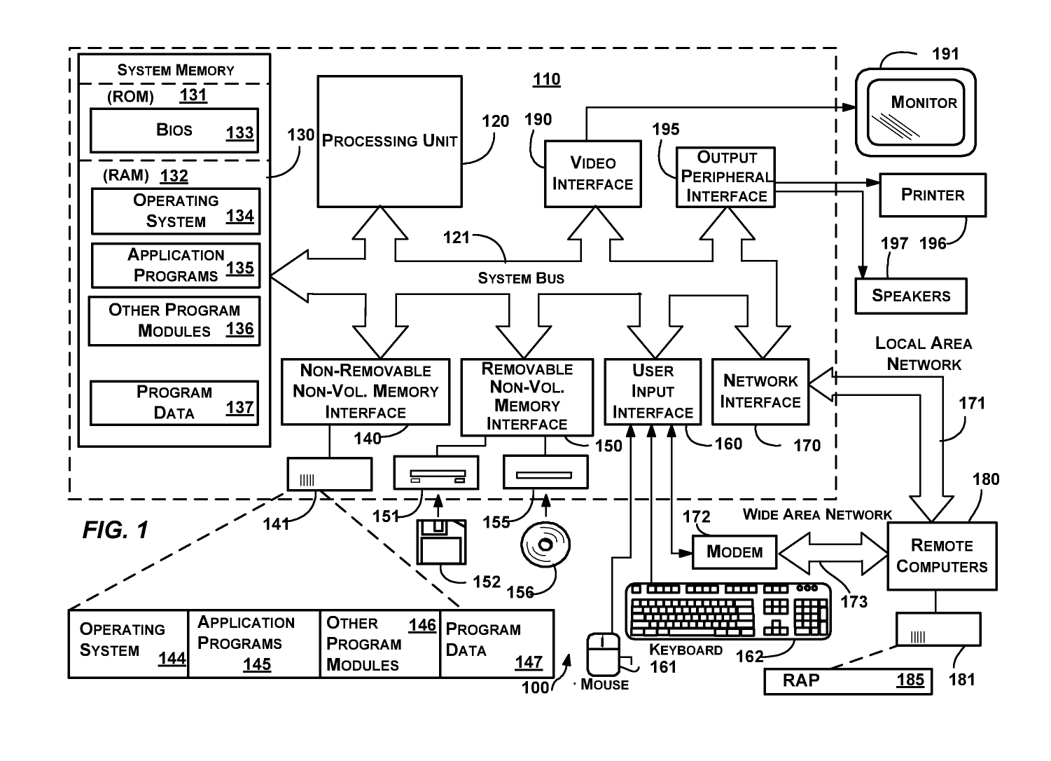

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Credential Synchronization

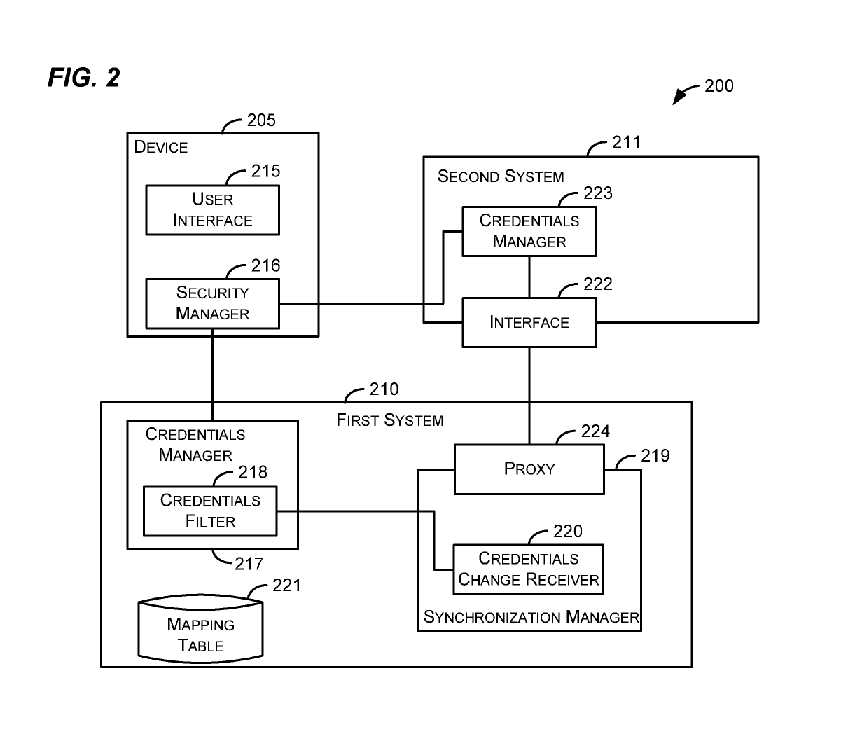

As mentioned previously, maintaining passwords on multiple systems is burdensome and may discourage organizations from adopting new technologies. FIG. 2 is a block diagram that represents an exemplary environment in which aspects of the subject matter described herein may be implemented. The environment 200 may include a device 205, a first system 210, a second system 211, and other components (not shown). The device 205 may include a user interface 215, a security manager 216, and other components (not shown). The first system 210 may include a credentials manager 217 a synchronization manager 219, a store 221, and other components (not shown). The second system may include a credentials manager 223, an interface 222, and other components (not shown).

As used herein, the term component is to be read to include hardware such as all or a portion of a device, a collection of one or more software modules or portions thereof, some combination of one or more software modules or portions thereof and one or more devices or portions thereof, and the like.

A component may include or be represented by code. Code includes instructions that indicate actions a computer is to take. Code may also include information other than actions the computer is to take such as data, resources, variables, definitions, relationships, associations, and the like.

The components illustrated in FIG. 2 are exemplary and are not meant to be all-inclusive of components that may be needed or included. In other embodiments, the components described in conjunction with FIG. 2 may be included in other components (shown or not shown) or placed in subcomponents without departing from the spirit or scope of aspects of the subject matter described herein. In some embodiments, the entities and/or functions described in conjunction with FIG. 2 may be distributed across multiple devices.

The components illustrated in FIG. 2 may be implemented using one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured to implement one or more of the components of FIG. 2 comprises the computer 110 of FIG. 1.

The first system 210 may include one or more devices that may provide access to resources to authorized entities. The first system 210 may be responsible for authenticating and authorizing users, computers, and other entities within a domain, enforcing security policies, installing and updating software on computers of the domain, and the like. The first system may include a directory service. The first system 210 may reachable from the device 205 over various networks including intra- and inter-office networks which may include one or more local area networks, wide area networks, direct connections, virtual connections, private networks, virtual private networks, some combination of the above, and the like.

In one embodiment, the second system 211 may be hosted in “the cloud.” In this embodiment, the second system 211 may have components that are distributed in various physical and logical places reachable via the Internet.

In one embodiment, the second system 211 may comprise a Web service reachable over the Internet. A service may include one or more processes, threads, components, libraries, and the like that perform a designated task. A service may be implemented in hardware, software, or a combination of hardware and software. A service may be distributed over multiple devices or may be implemented on a single device.

Both the first system 210 and the second system 211 may include security components that are charged with providing access to resources of the systems to entities that present valid credentials. Access as used herein may include reading data from, writing data to, deleting data from, updating data on, a combination including two or more of the above, and the like.

Credentials may include, for example, answers to challenge questions, a personal identification number (PIN), password, or other user-known data, biometric data (e.g., fingerprint, retina, DNA, or other biometric data), data from a portable item (e.g., a USB key, smart card, security device, or the like), other data that establishes the identity of an entity, a combination of two or more of the above, and the like.

To organize credentials and other properties, a security system may use records that include various data. A record may include, for example, one or more of an identifier, a principal name, a first name, a last name, a display name, an access level, a user role, a domain, license data, location data, other properties, and the like. For an entity that is able to access resources on both the first system 210 and the second system 211, the record on the first system 210 may include some of the same or different data of a corresponding record on the second system 211 for the user.

Among other things, the credentials manager 217 may be operable to update credentials on the first system 210. For example, the user interface 215 may provide a graphical interface with which a user may interact. A user using the device 205 may interact with the user interface 215 to send (e.g., via the security manager 216) a request to update credentials of the user on the first system 210. In response, the credentials manager 217 may receive the request and update a security object of the first system 210 to change the credentials as requested.

The user interface 215 may also display requirements for credentials of the second system to the user. For example, the second system 211 may have different password requirements than the first system 210. In changing the password of the first system 210, a user may desire to select a password that meets the requirements of both the first system 210 and the second system 211. To assist the user with changing the password, the proxy 224 may call the interface 222 of the second system 211 to obtain requirements for credentials of the second system. These requirements may then be provided for displaying on the user interface 215.

The credentials filter 218 may monitor or be informed of changes to credentials on the first system 210. If credentials for a user change, the credentials filter 218 may provide the credentials for sending to the second system 211 to update a security object of the second system 211 by sending the credentials to the credentials change receiver 220.

The credentials change receiver 220 may receive the changed credentials from the credentials filter 218 and store the changed credentials in a change repository preparatory for later asynchronously sending the second credentials to the second system 211. If the changed credentials come with an identifier of a corresponding security object of the second system, the credentials change receiver 220 may also store this identifier in the change repository. If the changed credentials do not come with such an identifier, the credentials change receiver 220 or another component of the synchronization manager 219 may use mapping data from the store 221 to determine an identifier of a corresponding security object of the second system 211 that is to be updated with the changed credentials.

The store 221 may be operable to maintain a data structure that maps security objects of the first system to security objects of a second system. For example, the store may map a security object of the first system to a security object of the second system by associating an identifier of the security object of the first system with an identifier of the security object of the second system. A security object may include any of the data of a record as described previously. In one implementation, there may be one security object per entity that has access to a system.

In one embodiment, the store 221 may maintain a table that maps security objects of the first system 210 to security objects of the second system 211. For example, in a table, each row may include an identifier of a security object of the first system 210 and an identifier (e.g., an email alias or other identifier) that identifies a security object of the second system 211.

The store 221 may be implemented using any storage media capable of storing data. The store 211 may include volatile memory (e.g., a cache), non-volatile memory (e.g., a persistent storage), storage media described in conjunction with FIG. 1, and the like. The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

The store 211 may be implemented as a database. As used herein a database may comprise a relational database, object-oriented database, hierarchical database, network database, other types of database, some combination or extension of the above, and the like. Data stored in a database may be organized in tables, records, objects, other data structures, and the like. The data stored in a database may be stored in dedicated database files, dedicated hard drive partitions, HTML files, XML files, spreadsheets, flat files, document files, configuration files, other files, and the like. A database may reference a set of data that is read-only to the database or may have the ability to read and write to the set of data.

Data in a database may be accessed via a database management system (DBMS). A DBMS may comprise one or more programs that control organization, storage, management, and retrieval of data of a database. A DBMS may receive requests to access data in a database and may perform the operations needed to provide this access.

In describing aspects of the subject matter described herein, for simplicity, terminology associated with relational databases is sometimes used herein. Although relational database terminology is sometimes used herein, the teachings herein may also be applied to other types of databases including those that have been mentioned previously.

When the synchronization manager 219 decides to update the second system, the synchronization manager 219 may instruct the proxy 224 to communicate with the second system 211. The proxy 224 may communicate with the second system via the interface 222. The interface 222 may be implemented, for example, as an application programming, Web, or other interface that receives messages potentially with parameters and passes the messages to the credential manager 223. The interface 222 may also send messages potentially with parameters to entities external to the second system 211.

Among other things, the credentials manager 223 may be operable to update credentials on the second system 210. In addition to communicating with entities (e.g., the user of the device 205) that seek to access resources of the second system 211, the credentials manager 223 may receive and send messages regarding credentials via the interface 222

For example, via the interface 222, the credential manager 223 may receive a message that includes a request to update credentials of a security object of the second system. In response, the credential manager 223 may update the credentials and respond by sending a message via the interface 222 that indicates success to the requestor.

As another example, if a corresponding security object does not exist on the second system 211, the proxy 225 may send a message to the credentials manager 223 to create a new account (and hence security object) on the second system 211. Via the interface 222, the credentials manager 223 may receive the message and create a new account and security object.

As another example, via the interface 222, the proxy 224 may request requirements for credentials of the second system 211 so that the proxy 224 may make these requirements available for displaying on a graphical interface such as the user interface 215 for when a user seeks to change credentials of an entity that is mapped to the second system 211.

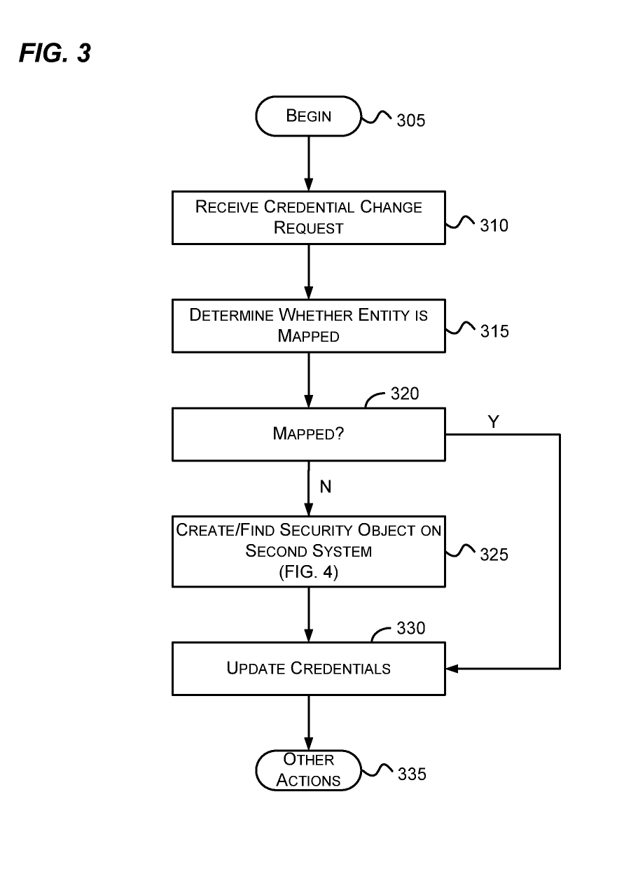

FIGS. 3-5 are flow diagrams that generally represent exemplary actions that may occur in accordance with aspects of the subject matter described herein. For simplicity of explanation, the methodology described in conjunction with FIGS. 3-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events

Turning to FIG. 3, at block 305, the actions begin. At block 310, a credentials change request is received. For example, referring to FIG. 2, the credentials manager 217 may receive a request to change credentials of the first system 210 from the device 205 for an entity of the first system 210.

At block 315, a determination may be made as to whether a data structure of the first system maps the entity to the second system that has the same credentials for the entity as the first system. For example, referring to FIG. 2, the credentials manager 217 may determine via a data structure of the mapping table 221 whether the entity using the device 205 and requesting a credential change is mapped to the second system 211. For example, if a row in the mapping table includes an identifier of a security object of the first system 210 and an identifier (e.g., an email alias or other identifier) of a security object of the second system 211, the credentials manager 217 may determine that the entity for which a credential change is requested is mapped.

At block 320, if the entity is mapped, the actions continue at block 330; otherwise, the actions continue at block 325. In one embodiment, if the entity is not mapped, the actions associated with blocks 325 and 330 are not performed. In this embodiment, if the entity is not mapped, there is no attempt to create/find a security object on the second system and then synchronize credentials. In this embodiment, a graphical interface may be provided to allow a user to map accounts between the two systems.

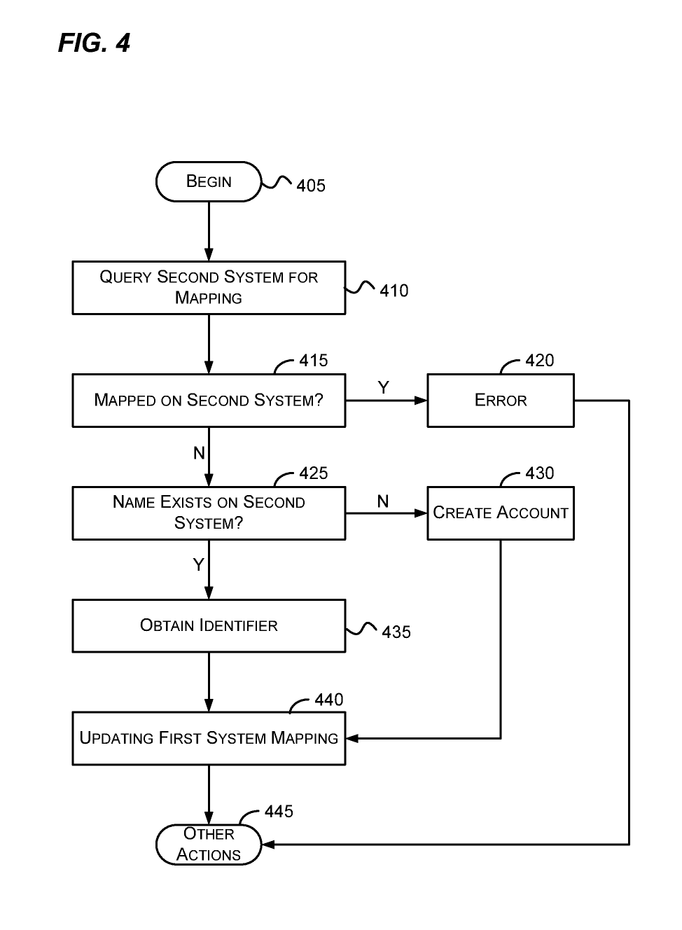

At block 325, a corresponding security object on the second system 211 may be found or created, if needed as described in more detail in conjunction with FIG. 4. For example, referring to FIG. 2, if the entity is not mapped, the synchronization manager 219 may find or create a corresponding security object on the second system 211 and map this found/created security object to the security object associated with the entity by storing an entry in the mapping table 221.

At block 330, credentials are updated. If the entity is mapped to the second system, this may involve communications between various components of the first system 210 and the second system 211. For example, the credentials filter 218 may inform the credentials change receiver 220 that credentials have changed on the first system. The credentials change receiver may store data regarding the change in a repository for later synchronization with the second system 211. When the synchronization manager 219 decides to synchronize the credentials, it may instruct the proxy 224 to update the credentials of the second system 211 to the data stored in the repository.

At block 335, other actions, if any, may be performed. Other actions may include, for example, synchronizing properties other than credentials, querying the second system to determine credential requirements, if any, other actions, and the like.

Turning to FIG. 4, actions corresponding to block 325 of FIG. 4 may be performed. At block 405, the actions begin.

At block 410, the second system is queried for a mapping. The second system may include a data structure that indicates mappings of security objects between the first system and the second system. Even if the data structure of the first system does not include a mapping of a security object for the entity to the second system, the second system's data structure may indicate this mapping. For example, referring to FIG. 2, the credentials manager 223 may be asked whether there is a mapping from security object of the second system to a security object of the first system.

At block 415, if the entity is mapped on the second system, the actions continue at block 420; otherwise, the actions continue at block 425.

At block 420, an error may be generated. Having a mapping on the second system but not on the first system may constitute an error. In this case, an error may be generated.

At block 425, if a name does not exist on the second system, the actions continue at block 430; otherwise, the actions continue at block 435. A user may want to have the user's email alias used to create accounts on the second system. This email alias may be considered a name. If this name does not already exists on the second system an account may be created; otherwise, an identifier of the security object that includes the alias may be obtained for mapping on the first system.

At block 430, an account is created on the second system. For example, referring to FIG. 2, the proxy 224 may be used to create an account on the second system 211. This account may then be mapped to an entity of the first system 210 via a mapping data structure of the store 221.

At block 435, an identifier of a security object of the second system is obtained. For example, referring to FIG. 2, the proxy 224 may obtain an email alias or other identifier of an account for a user via the interface 222.

At block 440, the first system mapping is updated. For example, referring to FIG. 2, a mapping data structure on the store 221 may be updated to map a security object of the first system 210 to the account found/created on the second system 211.

At block 445, other actions, if any, may be performed. After these other actions, if any, are performed, the actions may continue at block 330 of FIG. 3.

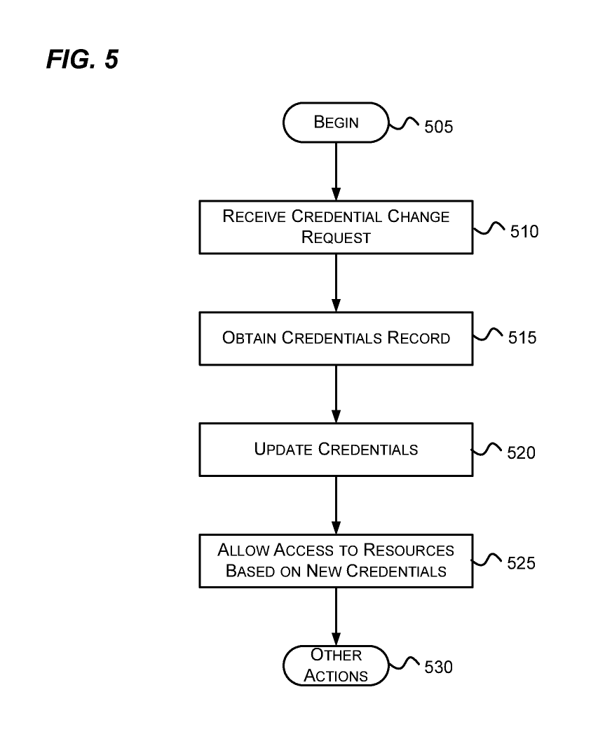

Turning to FIG. 5, at block 505, the actions begin. At block 510, a credential change request is received. For example, referring to FIG. 2, the second system 211 may receive a request to update credentials for an entity that is mapped to the second system 211 via a mapping data structure of the first system 210.

At block 515, a record is obtained that includes the credentials to change. For example, referring to FIG. 2, the credentials manager 223 may find a record that matches an identifier sent by the proxy 224.

At block 520, the record is updated such that the first credentials in the record are updated to the second credentials. For example, referring to FIG. 2, after the credentials manager 223 finds the record, it may update the credentials as requested.

At block 525, access to resources is allowed based on the new credentials. For example, referring to FIG. 2, after the credentials on the second system 211 have been updated, the credentials manager 223 may receive a request to access resources from the device 205. In making the request, the device 205 may provide the new credentials. In response, the credentials manager 223 may provide access to the resources.

At block 530, other actions, if any, may be performed.

As can be seen from the foregoing detailed description, aspects have been described related to credential synchronization. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving a request to change first credentials to second credentials for an entity of a first system, the first system providing access to a first set of resources to entities that provide valid credentials;
via a data structure of the first system, determining whether the entity is mapped to a second system with the first credentials for the entity, the second system providing access to a second set of resources to entities that provide valid credentials;
if the entity is mapped to the second system, informing a synchronization manager of the first system of the request to change the first credentials to the second credentials to use in updating the first credentials of the second system.

2. The method of claim 1, further comprising if the entity is not mapped to the second system via the data structure of the first system, querying the second system to determine if a data structure of the second system maps the entity to the second system.

3. The method of claim 2, further comprising if the data structure of the second system maps the entity to the second system and the data structure of the first system does not map the entity to the second system, generating an error.

4. The method of claim 2, further comprising if the data structure of the second system does not map the entity to the second system determining whether a name corresponding to the entity exists on the second system.

5. The method of claim 4, further comprising if the name exists, obtaining an identifier of a security object of the second system corresponding to the name and updating the data structure of the first system to map the entity to the second system.

6. The method of claim 4, further comprising if the name does not exist, creating an account on the second system with the name, and updating the data structure of the first system to map the entity to the account of the second system.

7. The method of claim 1, further comprising sending the second credentials to the second system via an interface exposed by the second system to use for updating the first credentials of the second system with the second credentials.

8. The method of claim 7, further comprising synchronizing a property other than the second credentials via the interface.

9. The method of claim 1, further comprising querying the second system to determine credential requirements, if any.

10. In a computing environment, a system, comprising:
a store operable to maintain a data structure that maps security objects of a first system to security objects of a second system, the security objects of the first system associated with entities that are allowed to access resources of the first system, the security objects of the second system associated with entities that are allowed to access resources of the second system;
a credentials manager operable to receive a request to update first credentials to second credentials for an entity, the credentials manager further operable to update a security object of the first system that includes the first credentials to change the first credentials to the second credentials; and
a credentials filter operable to provide the second credentials for sending to the second system to update a security object of the second system that is associated with the entity via the data structure, such that the second credentials allow access to a resource of the second system to which the first credentials used to provide access.

11. The system of claim 10, further comprising a credentials change receiver operable to receive the second credentials from the credentials filter at a first time and to store the second credentials in a change repository preparatory for asynchronously sending the second credentials at a second time to the second system.

12. The system of claim 10, further comprising a proxy operable to call an interface of the second system to update the security object of the second system with the second credentials.

13. The system of claim 10, further comprising a proxy operable to call an interface of the second system to create the security object of the second system when no security object of the second system is mapped to the security object of the first system via the data structure.

14. The system of claim 10, further comprising a proxy operable to call an interface of the second system to obtain requirements for credentials of the second system and to provide the requirements for displaying on a graphical interface.

15. The system of claim 10, further comprising a graphical interface operable to obtain input corresponding to the request and the second credentials and to provide, in response thereto, the request to the credentials manager.

16. The system of claim 10, wherein the first system comprises a directory service reachable over a local area network and the second system comprises a Web service reachable over the Internet.

17. The system of claim 10, wherein the store being operable to maintain a data structure that maps security objects of a first system to security objects of a second system comprises the store being operable to maintain a table that for each row includes an identifier of a security object of the first system and an email alias that identifies a security object of the second system.

18. The system of claim 10, further comprising a synchronization manager operable to update the security object of the second system second system with the second credentials in response to receiving the second credentials from the credentials filter.

19. A computer storage medium having computer-executable instructions, which when executed perform actions, comprising:
at a second system that includes first credentials for an entity that has access to a resource of the second system, from a first system that stores a mapping between entities of the first system and entities of the second system, receiving a request to update the first credentials to second credentials on the second system for the entity, the first system having already updated thereon the first credentials to the second credentials for the entity, the entity thereafter having access to a resource of the first system via the second credentials;
at the second system, obtaining a record that includes the first credentials based on an identifier included in the request; and
at the second system, updating the first credentials in the record to the second credentials.

20. The computer storage medium of claim 19, further comprising:
at the second system, after the updating the first credentials in the record to the second credentials, receiving a subsequent request to access the resource of the second system, the subsequent request provided in conjunction with providing the second credentials; and
at the second system, in response to the subsequent request, providing access to the resource of the second system.
